(19) United States
(12) Patent Application Publication
(10) Pub. No.: US 2023/0195101 A1
(43) Pub. Date: Jun. 22, 2023

(54) METHOD AND SYSTEM FOR DETECTING AND CHARACTERIZING WEAK SIGNALS OF RISK EXPOSURE IN AN INDUSTRIAL SYSTEM

(71) Applicant: Commissariat à l'énergie atomique et aux énergies alternatives, Paris (FR)

(72) Inventor: Hakima BERDOUZ QRICHI ANIBA, Paris (FR)

(73) Assignee: Commissariat à l'énergie atomique et aux énergies alternatives, Paris (FR)

(21) Appl. No.: 18/063,785

(22) Filed: Dec. 9, 2022

(30) Foreign Application Priority Data
Dec. 16, 2021 (FR) 21 13680

(51) Int. Cl. G05B 23/02

(52) U.S. Cl. CPC G05B 23/0283

(57) ABSTRACT

A method and system for detecting and characterizing weak signals of risk exposure in an industrial system based on industrial system data collected over a given time period. The system is configured for implementing:
a module (36) for computing a risk predictive signature, from collected data relating to the industrial system, using a first term obtained by summing elementary signatures associated with elementary initiating events, dependent on parameters comprising a severity value, a characteristic function and a weighting function of the elementary initiating event, at least a part of said parameters being determined by using a neural network,
a module (38) for detecting the presence of a weak signal of risk exposure by comparing the computed risk predictive signature with predetermined reference risk signatures.

This application claims priority to French Patent Application No. 21 13680 filed Dec. 16, 2021, the entire disclosure of which is incorporated by reference herein.

### FIELD OF THE INVENTION

The present invention relates to a method and system for detecting and characterizing weak signals of risk exposure in an industrial system.

### BACKGROUND OF THE INVENTION

The invention belongs to the field of system security, in particular the security of industrial systems, with the goal of early detection and prevention of significant events carrying a security risk.

In particular, the invention applies in the fields of anomaly detection, predictive maintenance, security supervision and safety analysis.

Within the context of the invention, a low risk exposure signal is defined as a feature linked to the state of the system at a time t, in particular to the industrial system, which is observed, the feature being measurable and likely to evolve over time.

A weak signal is the measurement (value) or impact at an instant t of an incubation defined as an accumulation or succession of elementary events, most often minor or negligible in terms of safety/security, announcing the realization of a trend, threat, anomaly and/or failure or even of a major event.

Within the context of the invention, risk refers to a risk that a significant event or a feared event will occur and hinder the functioning of the observed system, in particular of an observed industrial system. The risk is e.g. a risk of malfunction/anomaly of one or a plurality of subsystems, which can go as far as a failure.

The article “Learning about Risk: Machine learning for risk assessment”, by N. Paltrinieri et al, published in Safety Science, Vol. 118, 2019 states that continuous risk assessment plays a crucial role in industrial sectors with a strong security component, wherein learning lessons from operational feedback, the dissemination of good practices and the deployment of techniques [and] methods for processing and putting available big data to use, have to be associated with a capacity of predictive analysis and of anticipation in order to cope with unexpected events and control the associated risks and uncertainties.

A definition of risk was given in 1981 by Kaplan and Garrick. The definition states that the risk (R) can be expressed by what can go wrong (scenario s), the probability that what can go wrong will go wrong (probability p) and the severity of the consequences (consequence c):

R=f(s,p,c)

One of the issues addressed in the prior art is the consideration of dynamic evolutions vs. the analysis performed at the time of the design providing a static image of the risk.

More recently, a definition of risk taking the knowledge k further into account, has been proposed:

R=f(s,p,c,k)

The likelihood of a risk is the estimate of the feasibility or probability of a risk occurring, depending on the scale adopted (very low, implausible, almost certain, etc.).

A risk has an associated risk signature, which is a mathematical function modeling the exposure to risk over time. It is possible to calculate a risk score, which characterizes a quantification of the risk at a given instant of time. The score is the value at instant t of the risk signature.

The aim of the invention is to automate the early detection and characterization of weak signals which are precursors to the incubation of significant events so as to ensure the safety and security of the observed system.

The question of picking up and characterizing weak signals, precursors of a significant or critical event (also called a “feared event”), arises more generally, in the industrial field, in the field of monitoring the risk of natural disasters and also in the field of health.

The notion of weak signals, precursors to the incubation of feared events, has been defined more generally, particularly in social sciences. It has been demonstrated a posteriori that any failure would have a precursor signal called a weak signal.

A main difficulty is the a priori detection and early characterization of such weak signals with respect to random signals, which are termed noise, the observable weak signals as such being generally noisy to a certain extent.

Various approaches to detecting and characterizing weak signals have been implemented, including a symbolic approach and a numerical approach. The symbolic approach is based on rules-based reasoning models and systems, attempting to reproduce the cognitive mechanisms of an expert. Such approach is limited to particular cases. The numerical approach uses artificial neural networks applied to numerical data, based on machine learning. Such approach can be complex, and in particular allow searches of data to be carried out a posteriori, after the occurrence of a feared event. Upstream and a priori detection of weak signals remains problematic.

Patent FR 3009615 describes a method and a system for detecting and characterizing weak signals compared to a given threshold value, where a signal is associated with a quantity of energy and is emitted by one or a plurality of sources to be monitored within a system. Such method implements a computation of a signature expressing an energy value of a detected signal associated with an event, as a function of a severity G of an event having had an impact on the source emitting the signal, a probability of occurrence of the event and a function MR representing the control of the risk. The risk control function is weighted by parameters representing means, skills and methods deployed in prevention. Such method is used for detecting weak signals which are precursors of a significant event (e.g. a malfunction) by comparison with given thresholds.

The subject matter of the invention is to propose an improved method for characterizing weak signals, compared with said method for the prior art, in the application to the industrial field.

### SUMMARY OF THE INVENTION

To this end, the invention proposes, according to one aspect, a method for detecting and characterizing weak signals of exposure to a risk in an industrial system, a weak signal being representative of an incubation of a feared event, from data relating to the industrial system collected by at least one sensor over a given time period. The method comprises the following steps, implemented by a processor:
from data relating to said industrial system, collected during said period, computation of a risk predictive signature defining an incubation function, the risk predictive signature comprising a first term obtained by summing elementary signatures associated with elementary initiating events, each elementary signature being dependent on parameters comprising a severity value of the elementary initiating event, a characteristic function of the elementary initiating event and a weighting function associated with the elementary initiating event, at least a part of said parameters being determined by implementing a neural network,
detection of the presence of at least one weak signal of risk exposure by comparing the computed risk predictive signature with predetermined reference risk signatures,
in the event of a positive detection, determination of a reference predictive signature associated with the predictive signature of the computed risk and characterization of the risk associated with said reference risk signature, said characterization including a display of a threat scenario determined beforehand and recorded in association with said reference predictive signature.

Advantageously, the method for detecting and characterizing weak signals of risk exposure in an industrial system implements a risk predictive signature, computed as a function of elementary initiating events, taking into account parameters determined by implementing artificial intelligence (AI) methods.

Advantageously, the proposed approach is a multi-modal approach combining the symbolic approach and the numerical approach.

The method for detecting and characterizing weak signals of risk exposure according to the invention can further have one or a plurality of the features hereinafter, taken independently or according to all technically feasible combinations.

The weighting function associated with the elementary initiating event is a deterministic-probabilistic function, dependent on a probability of said elementary initiating event related to said feared event.

The risk predictive signature includes a second term which is dependent on pairs of elementary initiating events and a characteristic inter-correlation function for each pair of elementary initiating events.

The computation of a risk predictive signature also takes into account, a probabilistic characteristic function of noise relative to the collected data.

The elementary signature of an elementary initiating event Eᵢ is provided by the following formula:

Sig_Eᵢ(t)=f(Gᵢ(x,t)ⁿwᵢ(x,t)σᵢ(x,t)

Where f(Gᵢ(x,t))ⁿ is a characteristic function of the severity of the elementary initiating event Eᵢ, defined over a spatial perimeter and over a time period, n being an integer parameter,

σᵢ(x,t) is the characteristic function of the elementary initiating event Eᵢ and

wᵢ(x,t) is the weighting function associated with the elementary initiating event Eᵢ.

The risk predictive signature is computed according to the formula:

$$Γ ( \text{} t ) = [ \text{} {\sum }_{i} S i {g}_{-} {E}_{i} ( t ) + {\sum }_{jk} {ξ}_{jk} {w}_{j} ( x , t ) {w}_{k} ( x , t ) < f ( {G}_{i} ( x , t ) ) ∧ f ( G , ( x , t ) ) > ] * B ( t ) ,$$

Where ξⱼₖ is a characteristic inter-correlation function between elementary initiating events Eⱼ and Eₖ, <f(Gᵢ (x, t))∧f(Gⱼ(x, t))> indicates a function linking the characteristic severity functions of the initiating events Eⱼ and Eₖ, and B(x,t) is a probabilistic function characterizing a noise.

The characteristic severity function of an elementary initiating event takes four different values representative of zero severity, minor severity, significant severity or severe severity, respectively.

The data relating to the industrial system are representative values of the equipment of the industrial system, and data are collected by one or a plurality of sensors.

The method includes, following the collection of data relating to the industrial system during said period, a preprocessing of said collected data so as to format said collected data into numerical data, and a classification by a classifier of said numerical data for obtaining parameter values associated with the elementary initiating events.

The method includes a phase of initializing a database of reference risk signatures, in relation to a set of feared events, depending on data collected for industrial systems and on expert validations, and a memorization of reference risk signatures, associated threat scenarios and an associated risk map.

According to another aspect, the invention relates to a system for detecting and characterizing weak signals of risk exposure in an industrial system, wherein a weak signal is representative of an incubation of a feared event, based on data relating to the industrial system, collected by at least one sensor over a given time period. The system includes at least one computation system, including a processor configured for implementing:
a module for computing, on the basis of data relating to the industrial system collected during said period, a risk predictive signature, the risk predictive signature comprising a first term obtained by summing elementary signatures associated with elementary initiating events, each elementary signature being dependent on parameters comprising a severity value of the elementary initiating event, a characteristic function of the elementary initiating event and a weighting function associated with the elementary initiating event, at least a part of said parameters being determined by implementing a neural network,
a module for detecting the presence of at least one weak signal of risk exposure by comparing the computed risk predictive signature with predetermined reference risk signatures,

in the event of a positive detection, applying a module for determining a reference predictive signature associated with the predictive signature of the computed risk for characterizing the risk associated with said reference risk signature including a module for displaying a threat scenario which was determined beforehand and recorded in association with said reference predictive signature.

According to another aspect, the invention relates to a computer program including software instructions which, when implemented by a programmable electronic device, implement a method for detecting and characterizing weak signals of risk exposure, such as briefly described hereinabove.

### BRIEF DESCRIPTION OF THE DRAWINGS

Other features and advantages of the invention will be clear from the description thereof which is given below as a non-limiting example, with reference to the enclosed figures, among which:

FIG. 1 is a synoptic presentation of a system for detecting and characterizing weak signals of risk exposure in an industrial system according to one embodiment;

FIG. 2 is a synoptic presentation of the main steps of an initialization phase of a method for detecting and characterizing weak signals of risk exposure, according to one embodiment;

FIG. 3 is a synoptic presentation of the main steps of computation phase of a risk predictive signature within a method for detecting and characterizing weak signals of risk exposure, in one embodiment;

FIG. 4 is a synoptic presentation of the main steps of a characterization phase for weak signals of risk exposure in one embodiment;

FIG. 5 illustrates a schematic example of an industrial system wherein the invention finds an application.

### DETAILED DESCRIPTION OF EMBODIMENTS

The invention will be described herein in a few embodiments, in particular in its application thereof to the detection and characterization of weak signals of exposure of an industrial system to a risk of hardware failure of one of the components thereof.

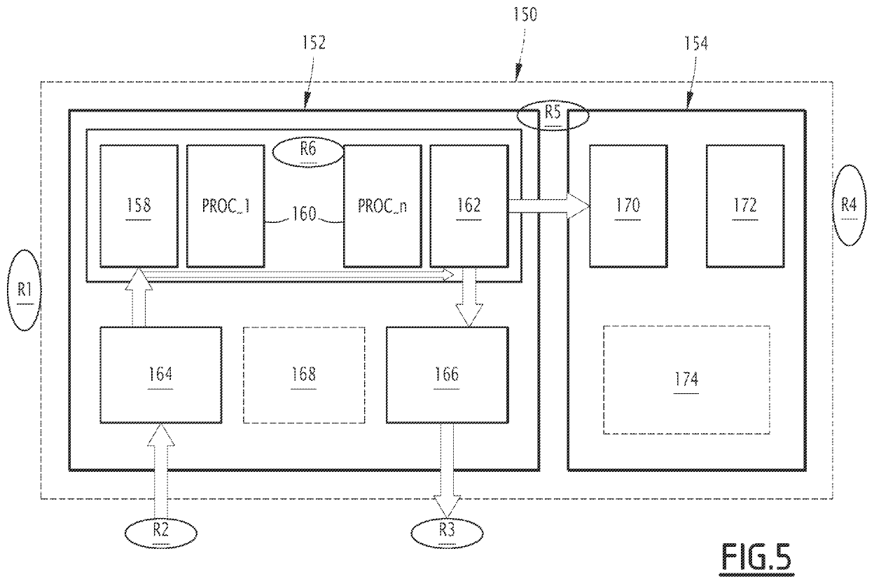

An example of application of the invention within the framework of a particular industrial system, which is a nuclear facility, will be described below with reference to FIG. 5. Of course, such example of application of the invention is not limiting.

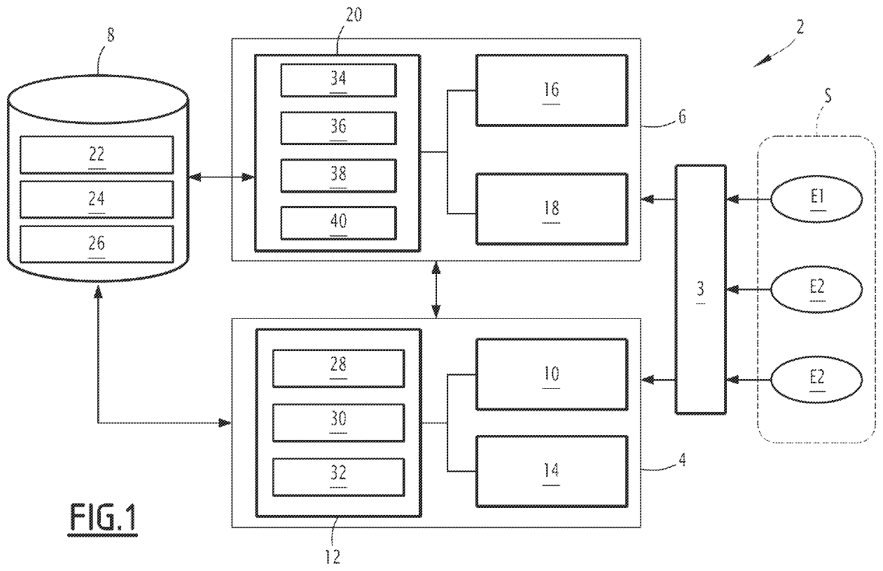

FIG. 1 schematically illustrates a system 2 for detecting and characterizing weak signals of exposure of an industrial system to a risk.

The industrial system observed, reference S in FIG. 1, includes a plurality of elements which are sources S1, S2, S3 which emit physical quantities (e.g. alarm transfer, reading of operating measurements, deviation or anomaly, technical fact), which are picked up by one or a plurality of sensors 3. Of course, in practice, the number of emitting sources observed is arbitrary.

Such collected physical quantities form measured signals, as a function of time, which are likely to contain signals which relate to elementary initiating events relating to a feared risk (malfunction, failure, overheating or exceeding acceptable operating values, etc.).

The system 2 comprises a first computation system 4 and a second computation system 6. In one embodiment, each of the computation systems 4, 6 consists of one or a plurality of programmable electronic devices, e.g. computers, suitable for performing computations.

The computation systems 4, 6 are suitable for communicating—read and write—with a data storage system 8 which comprises databases stored on one or a plurality of electronic memory units.

The first computation system 4 includes a computation unit 10, consisting of one or a plurality of processors, associated with an electronic memory unit 12 and with a human-machine interface 14.

The second computation system 6 includes a computation unit 16, consisting of one or a plurality of processors, associated with an electronic memory unit 20 and with a human-machine interface 18.

The first computation system 4 is configured for implementing a phase of initialization of a method for detecting and characterizing weak signals of risk exposure, in relation to at least one predefined observation perimeter, in particular a spatial perimeter, including a set of sources S1, S2, S3 observed, used for generating or enriching databases comprising:
a database 22 of elementary initiating events and associated parameters characterizing risks for the predefined perimeter of the industrial system;
a base 24 of reference risk signatures and associated threat scenarios;
an associated risk map 26 is optionally stored.

Herein, the threat scenario associated with a risk, also called a risk scenario, refers to a complete evolution scenario starting from the source of the risk, e.g. one or a plurality of elementary initiating events to the development thereof.

An elementary initiating event is characterized by one or a plurality of parameters outside a range of nominal values, representative of a weak signal precursor to the risk. Deviations from nominal operating values, alarm transfers of predefined alarm types are e.g. concerned. Minor deviations, below an alert threshold, i.e. below a given threshold value are e.g. concerned.

For example, a threat scenario associated with risk describes temporal changes, e.g. a frequency of alarm transfer or a curve of the increase of deviations from nominal operating values used for predicting a risk e.g. of overheating and of fire.

In other words, a threat scenario is a kinetic model of the feared risk, also called a “mechanistic model”.

An associated map is a visual representation, e.g. in the form of a 2D or 3D diagram, of the risks which can affect the industrial system S observed.

The databases 22, 24, 26 are stored by the data storage system 8. The data storage system is a computer-readable medium, e.g. a medium apt to store the electronic instructions and to be coupled to a bus of a computer system. As an example, the readable medium is an optical disk, a magneto-optical disk, a ROM memory, a RAM memory, any type of non-volatile memory (e.g. EPROM, EEPROM, FLASH, NVRAM), a magnetic card or an optical card.

The computation unit 10 configured for implementing a module 28 for selecting and validating risk models associated with the observation perimeter, a module 30 for computing reference risk signatures, associated threat scenarios and associated risk map, and a module 32 for update validation.

Each risk is modeled by a multi-physics model based on data collected [from a] plurality of industrial systems (e.g. at a plurality of nuclear facility sites) over a time period, where the model can be updated depending on the events observed, as explained in more detail hereinafter.

In one embodiment, for a perimeter of observation, a plurality of risks are considered, each risk having an associated risk model, and an overall risk model, taking into account the interdependencies and correlations between the risks, is obtained.

An example of application in a nuclear facility will be detailed hereinafter with reference to FIG. 5.

The second computation system 6 is configured for implementing a method for detecting and characterizing weak risk signals for the industrial system S.

The computation unit 16 is configured for implementing:
a module 34 for collecting data relating to the industrial system during a given time period, the data collected including in particular measurements obtained by the sensor or sensors 3, from the emitting sources S1, S2, S3;
a module 36 for computing a risk predictive signature;
a module 38 for detecting the presence of at least one weak signal of risk exposure by comparing the risk predictive signature with reference risk signatures;
a module 40 for determining a reference predictive signature associated with the computed risk predictive signature and risk characterization associated with the reference risk signature, the module further including a module for displaying data on the human-machine interface 18, in particular on a display screen of the interface.

In one embodiment, the modules 34, 36, 38, 40 are embodied in the form of software code, and form a computer program, including software instructions which, when implemented by a programmable electronic device, implement a method for detecting and characterizing weak signals of risk exposure.

In a variant (not shown), the modules 34, 36, 38, 40 are each embodied in the form of a programmable logic component, such as an FPGA (Field Programmable Gate Array) or a GPGPU (General-purpose processing on graphics processing), or further in the form of a dedicated integrated circuit, such as an ASIC (Application Specific Integrated Circuit). The computer program for detecting and characterizing weak signals of risk exposure is further apt to be recorded on a computer-readable medium (not shown). The computer-readable medium is e.g. a medium apt to store the electronic instructions and to be coupled to a bus of a computer system. As an example, the readable medium is an optical disk, a magneto-optical disk, a ROM memory, a RAM memory, any type of non-volatile memory (e.g. EPROM, EEPROM, FLASH, NVRAM), a magnetic card or an optical card.

Similarly, the modules 28, 30, 32 are implemented in the form of software code and form a computer program. In a variant (not shown), the modules 28, 30, 32 are each embodied in the form of a programmable logic component, such as an FPGA (Field Programmable Gate Array) or a GPGPU (General-purpose processing on graphics processing), or further in the form of a dedicated integrated circuit, such as an ASIC (Application Specific Integrated Circuit).

The first computation system 4 and the second computation system 6 are shown herein in the form of distinct computation systems.

In a variant (not shown), the two computation systems 4, 6 are brought together in one computation system, which performs both the initialization phase for an observation perimeter of the industrial system and the processing phase of the data collected for the industrial system for the characterization and prediction of weak signals of risk exposure.

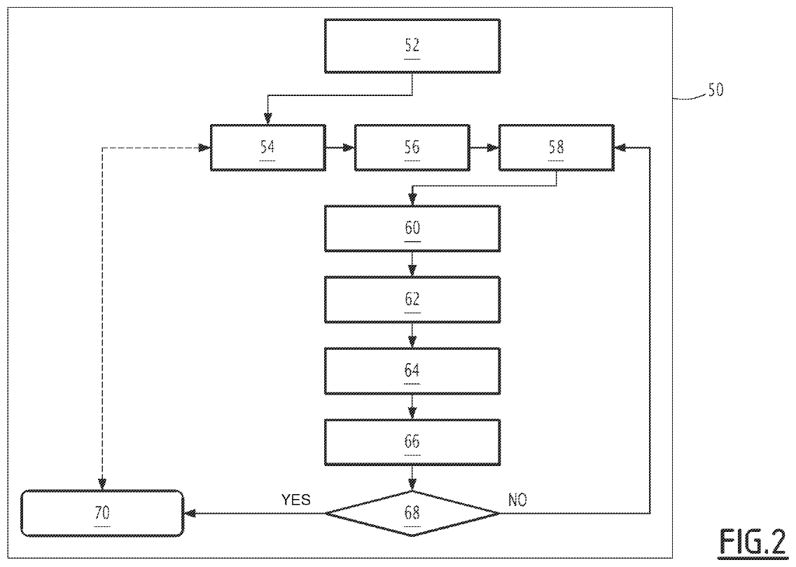

FIG. 2 is a synoptic presentation of the main steps of an initialization phase 50 of a method for detecting and characterizing weak signals of risk exposure, in one embodiment.

The initialization phase is a phase prior to the implementation of the method for an observed industrial system, in an observation perimeter including a plurality of emitting sources, and the purpose thereof is to generate and store data:
from the database 22 of elementary initiating events and of associated parameters, characterizing risks for the industrial system;
from the database 24 of reference risk signatures and of associated threat scenarios;
from the associated risk map 26.

Advantageously, the initialization phase is carried out, in connection with the observation perimeter and with a predefined set of risks, according to data collected on one or a plurality of industrial systems of the same type, collected during the operating phases of said systems, and to expert validations.

The initialization phase 50 e.g. is conducted by a professional who is an expert on the operational safety of the chosen industrial system.

The initialization phase e.g. implements an operational experience feedback (or REX, in French) scheme, using the analysis of data recorded prior to the occurrence of accidents in industrial systems.

In one embodiment, the initialization phase is conducted by an operational safety expert who uses a human-machine interface (e.g. screen and keyboard, touch screen, voice control interface, etc.) allowing the expert to select an observation perimeter and a set of feared risks.

The method then comprises a selection 54 of data collected beforehand, e.g. stored beforehand in one or a plurality of databases, relating to the data collected in connection with the risk or feared risks.

Moreover, the expert has the possibility during the step 56, of selecting artificial intelligence (AI) learning algorithms and models, to be deployed within the method, among a plurality of such models and algorithms proposed, e.g. from performance evaluations resulting from operational experience feedback or from the scientific literature. It is possible e.g. to use deep learning algorithms using artificial neural networks, in an automated way, among:
supervised learning based on convolutional neural networks (CNN), comprising a plurality of layers, which are optionally fully connected;
semi-supervised learning based e.g. on deep neural networks (DNN);
unsupervised learning based e.g. on long-short term memory (or LSTM) recurrent neural networks (RNNs), comprising one or a plurality of LSTM layers.

The method further comprises a step 58 of obtaining “multi-physics models” of the risk or risks to be investigated.

The term “multi-physics model of risk” is used herein for describing a model integrating a plurality of parameters for characterizing the risk, which are quantifiable, e.g. deviations from nominal operating values and alarm transfers.

Such a model defines elementary initiating events for a risk, the use of which is described in more detail hereinafter.

The model collection step 58 is e.g. implemented by using an artificial intelligence algorithm among the algorithms mentioned hereinabove, trained during the learning phase on the data collected during the selection step 54.

According to one embodiment, the model collection step 58 makes a selection from models provided by experts, the selection being e.g. performed on a chosen performance criterion.

According to one variant, the model collection step 58 builds a risk model from the data collected during the step 54.

Preferentially, the method further comprises a step 60 of validation by interaction with the expert, making an incremental validation of the intermediate results possible, for e.g. refining and reinforcing the learning.

In one embodiment e.g., the step 60 is performed by a question and answer (QA) module, e.g. implemented in the form of a chatbot. Such a step 60 of validation by interaction is part of a HILL (Human in the Loop Learning) process, which allows the results obtained automatically by machine learning to be improved.

The method further comprises a step 62 of multi-scale coupling of multi-physics models of risk and of associated uncertainties, used for obtaining parameters associated with elementary initiating events, for computing a risk predictive signature, formed from signatures called elementary signatures of initiating events, as discussed in detail hereinafter.

Multi-scale coupling is implemented by the artificial intelligence model selected during the selection step 56.

Multi-scale coupling refers herein to taking into account, spatial perimeters defined at a plurality of scales. E.g. for an industrial site, e.g. a nuclear site, spatial perimeters at different scales comprise the facility as a whole on a first scale, a specific building on a second scale, a set of restricted access rooms enclosing equipment for which the safety is critical on a third scale, etc. A concrete example relating to an industrial system will be given in detail hereinafter, with reference to FIG. 5.

A model is defined for each scale, and the multi-scale coupling takes into account the interactions between scales, e.g. starting from the most elementary level (corresponding to the Nth scale, N being the total number of scales in the notation chosen hereinabove), and by weighting the contribution from an n-scale level to an n-1-scale level.

The term uncertainty associated with the model refers herein to a probabilistic uncertainty, as computed by a probabilistic computation method with respect to the data collected.

Indeed, the data collected are generally biased or noisy at the source, given the uncertainties associated with the systems and methods for acquiring data at the source, of the processing and saving thereof.

The mathematical models used also generate additional uncertainties related to the differences between the actual model describing the mechanical philosophy and phenomenology of risk exposure and the approximations deployed according to the available data.

To assess such uncertainty, a plurality of methods are described by the prior art. The use of a probability law, such as Poisson's law which applies to the occurrence of low probability events or Gauss's law (or normal law) that is the most widely used probability law, are evidence therefrom. The interest thereof is confirmed if the following conditions are met simultaneously:
There are many causes of error;
The errors have the same order of magnitude;

Fluctuations related to different causes of error are independent and additive.

The method further comprises a step 64 of computing a risk map and of a deterministic-probabilistic modeling of risk and associated threats.

Deterministic-probabilistic modeling comprises taking into account deterministic parameters (e.g. obsolete industrial system equipment, date of machine operation, frequency of machine use, operating conditions (ambient temperature, relative humidity)), which modify the probability uncertainty computations associated with the risk.

For a risk considered, a classification into a plurality of classes is applied by neural networks or by random forests, according to the deterministic-probabilistic modeling, and for each class, a reference risk signature is computed which is stored in the database 24, as well as an associated threat scenario.

The elementary signature of an elementary initiating event Eᵢ is defined by the following formula:

Sig_Eᵢ(t)=f(Gᵢ(x,t)ⁿwᵢ(x,t)σᵢ(x,t) [MATH1]

where f(Gᵢ(x, t)ⁿ is the characteristic function of the severity of the elementary initiating event Eᵢ, n being a parameter, preferentially comprised between 1/2 and 5/2 included, defined over a spatial perimeter Per_s=[x,x+Δx] and over a time period Per_t=[τ, τ+Δτ];

f(X) is a function of a variable X, e.g.:

f(X)=2^{X} where

f(X)=Xⁿ where n is a real number, or

f(X)=Xe^{-X}^{²}

σᵢ(x, t) is the characteristic function of the elementary initiating event Eᵢ and wᵢ(x,t) is the weighting function associated with the elementary initiating event Eᵢ.

The characterizing function of severity e.g. is a function of the elementary initiating event.

In one embodiment, the characteristic severity function can take four different values representative of zero severity, minor severity, significant severity or severe severity, respectively, for a value x of the chosen perimeter and a time t:

$${G}_{i} ( x , t ) = \{ \begin{matrix}{λ}_{1}^{i} \\ {λ}_{2}^{i} \\ {λ}_{3}^{i} \\ {λ}_{4}^{i}\end{matrix}$$

where λₖⁱ is the kth severity value for the elementary initiating event Eᵢ.

For example λ₁ⁱ=0, for zero severity, λ₂ⁱ=1 for minor severity, λ₃ⁱ=2 for significant severity, and λ₄ⁱ=3 for severe severity.

The characteristic function of an elementary initiating event Eᵢ takes e.g. the values 0 or 1, depending on the state of realization of the event:

σᵢ(x, t)=1 if Eᵢ is realized

σᵢ(x, t)=0 otherwise.

The weighting function wᵢ(x, t) is e.g. a parameter set by an expert or a deterministic-probabilistic function associated with an elementary initiating event Eᵢ, characterized by a severity Gᵢ(x,t), and a probability ρᵢ.

A formula for the weight e.g. is:

$${w}_{i} = {p}_{i} * \frac{{\prod }_{k} {V}_{i k}}{{( {\sum }_{k} {Ψ}_{i k}^{m} )}^{\frac{1}{n}}} \qquad [ MATH 2 ]$$

Where Vᵢₖ is a value representative of an intrinsic vulnerability to the industrial system S relatively and ωᵢₖ a characteristic of an associated defense barrier.

In one embodiment, the risk predictive signature is computed according to the following formula which gives Γ(t), also called the incubation function.

The incubation function is a multi-variable mathematical function, depending on a plurality of time, space, quantitative and/or qualitative variables.

The incubation function is defined hereinafter from characteristic signatures of elementary events, over a spatial perimeter and a time period, as indicated hereinabove.

r(t)=[Σᵢf(Gᵢ(x,t))wᵢ(x,t)σᵢ(x,t)+Σⱼₖξⱼₖwⱼ(x,t)wₖ(x,t)<f(Gᵢ(x,t))∧f(Gⱼ(x,t))>]*B(t)[MATH3]

Where:
f(Gᵢ(x,t)) is the characteristic function of the severity of the elementary initiating event Eᵢ,
σᵢ(x, t) is the characteristic function of the elementary initiating event Eᵢ,
wᵢ(x, t) is the weighting function associated with the elementary initiating event Eᵢ;
ξⱼₖ (x, t) is a characteristic inter-correlation function between elementary initiating events Eⱼ and Eₖ, and B(x,t) is a probabilistic function characterizing a noise,
the notation <f(Gᵢ(x, t))∧f(Gⱼ (x, t))> indicates a function linking the severity characteristic functions of the initiating events Eᵢ and Eⱼ, e.g.:

<f(Gᵢ(x,t))∧f(Gⱼ(x,t))>=f(Gᵢ(x,t))×f(Gⱼ(x,t))

The characteristic function of inter-correlation between two elementary initiating events can be written:

ξⱼₖ=(σⱼ|σₖ)

For example:

ξⱼₖ=1 if the correlation of the elementary initiating events Eᵢ and Eₖ brings an aggravating negative effect;

ξⱼₖ=0 if the correlation of the elementary initiating events Eⱼ and Eₖ brings no effect, in other words is neutral;

ξⱼₖ=−1 if the correlation of the elementary initiating events Eⱼ and Eₖ brings a positive protective effect.

More generally, if the correlation of the elementary initiating events Eᵢ and Eₖ brings an aggravating negative effect take a first correlation value, preferentially a positive value, if the correlation of the elementary initiating events Eⱼ and Eₖ brings a positive protective effect, take a second correlation value, preferentially negative.

The weak signal is defined by the source term Ω characterizing the drift of the incubation on the spatial perimeter Per_s and the time period Per_t:

$$Ω ( x , t ) = \frac{\partial Γ}{\partial t} + \frac{{\partial }^{2} Γ}{{\partial }^{2} x} \qquad [ MATH 4 ]$$

It is also possible, according to one variant, to take into account one or a plurality of other variables Xᵢ, specific to the monitored system, which form an additional constraint:

$$Ω ( x , t ) = \frac{\partial Γ}{\partial t} + \frac{{\partial }^{2} Γ}{{\partial }^{2} x} + \frac{\partial Γ}{\partial {X}_{i}} \qquad [ MATH 5 ]$$

According to one variant, a plurality of variables are taken into account, weighted by parameters βᵢ characterizing the “importance” of each variable:

$$Ω ( x , t ) = \frac{\partial Γ}{\partial t} + \frac{{\partial }^{2} Γ}{{\partial }^{2} x} + \sum {β}_{i} \frac{\partial Γ}{\partial {X}_{i}} \qquad [ MATH 6 ]$$

For example, the parameters βᵢ are increasing with the importance, i.e. the contribution, of each variable in the threat scenario considered.

The parameters βᵢ are e.g. real weighting values, positive and less than 1, the total sum of which is normalized to 100%.

The B(x,t) noise can be filtered through the implementation of known mathematical functions, resulting in a filtered incubation function noted:

\hat{Γ}(t)=[Σᵢf(Gᵢ(x,t))wᵢ(x,t)σᵢ(x,t)+Σⱼₖξⱼₖwⱼ(x,t)wₖ(x,t)<f(Gᵢ(x,t))∧f(Gⱼ(x,t))>] [MATH 7]

The characterization of the weighting factors wᵢ(x,t) is preferentially carried out by AI (“artificial intelligence”) training by reinforcement so as to increase the precision and customization of the elementary initiating events.

The method optionally comprises another step 66 of interactive validation by an expert, similar to the step 60 described hereinabove.

In particular, the expert validates the results of the steps 62 and 64.

In case of positive validation (answer ‘yes’ to the test 68), the database 22 of elementary initiating events and associated parameters characterizing risks for the predefined perimeter, the database 24 of reference risk signatures and associated threat scenarios and the associated risk map 26 are updated (step 70) with the results of the steps 62 and 64.

In case of negative validation (answer ‘no’ to the test 68), the method returns to the step 58 of selecting multi-physics models of the risk, and the steps 60 to 68 are iterated.

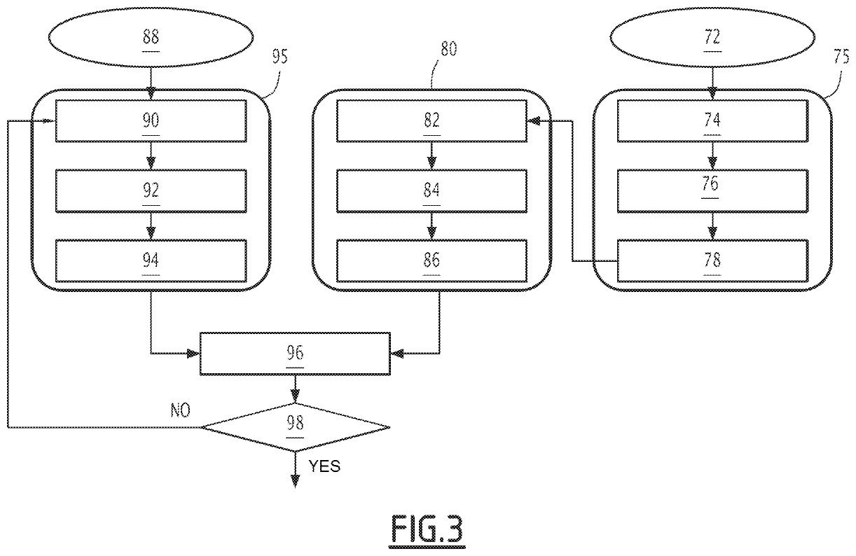

FIG. 3 is a synoptic presentation of the main steps of a phase of computation and assessment of risk signature within the method for detecting and characterizing weak signals of risk exposure in an observed industrial system, in one embodiment.

The method receives as input data 72 relating to the observed industrial system, depending on a spatial observation perimeter, collected by one or a plurality of sensors, during a given time period, called the monitoring period, e.g. a week, 15 days or one month.

The data 72 relating to the industrial system can also include descriptive data of the spatial perimeter of observation, e.g. historical data such as the date of commissioning of each equipment item or machine observed, the frequency of use of the machine, context data (temperature, relative humidity, presence of corrosive substances, etc).

Such data 72 are collected during a collection step 74, e.g. in the form of files which contain the data and/or by input by an operator. The collected data 72 is called raw data.

The raw data are preprocessed during a preprocessing step 76, the preprocessing consisting of formatting, or in other words of structuring and converting the raw data into numerical data which can subsequently be used by automatic processing algorithms. The pre-processing step is performed by automatic processing based on predetermined rules.

The method then includes a step 78 of classification of the numerical data obtained in the step 76 by an artificial intelligence method. The step 78 applies e.g. a classifier, implemented by an artificial intelligence algorithm, such as a neural network, or a decision tree or a forest network, trained in a prior learning phase.

The parameters defining the elementary initiating events and the associated severity and weighting values, are obtained at the output of the data classification step 78.

The elementary initiating events associated with the risk which is sought to be characterized, are defined by the risk model computed and stored during the initialization phase 50.

The steps 74, 76 and 78 contribute to a preprocessing 75 of the collected data 72 relating to the industrial system.

The pre-processing 75 is followed by a predictive assessment 80 of the risk of occurrence of a feared event.

The predictive assessment comprises a predictive signature computation 82 of the feared risk using the formula MATH 3] or [MATH 7] in one embodiment.

The method then includes a step 84 of statistical evaluation of uncertainties associated with the computed risk predictive signature, the evaluation taking into account the uncertainties associated with the data, models and algorithms.

The statistical evaluation of uncertainties is carried out by a statistical computation method, e.g. by using a normal law or a Poisson law according to one of the methods known in the prior art.

The method further comprises a step 86 of temporal evaluation of the incubation function or risk predictive signature, according to the formula MATH 3] or [MATH 7] over the monitoring period, with a chosen time frequency. Thus, a time-dependent sampling of the risk predictive incubation function (or risk predictive signature) is obtained, over a given length of time, forming a curve of the evolution of risk. The length of time is e.g. one or a plurality of weeks or months.

In the embodiment described, substantially in parallel with the predictive assessment 80 of the risk for the industrial system in question, a parallel assessment 95 is used on the basis of stored data 88, also called operational experience feedback (REX) data.

The purpose of the assessment 95 performed is to allow for an interactive updating of the models stored in the databases 22, 24 according to the data collected, thus refining the risk models, the reference risk signatures and the associated threat scenarios.

Moreover, such assessment makes it possible to highlight rare but nevertheless possible scenarios, having a very low probability of occurrence but corresponding to a feared scenario for the industrial system.

The assessment 95 includes a step 90 of obtaining a reference risk signature and a mechanistic model of the associated risk. The reference risk signature is closest to the model computed for the industrial system considered, from the stored data 88, in particular from the databases 22, 24.

During a step 92, a prediction of the evolution of the risk for industrial system is then computed, over the same length of time as same used in step 84, using the reference risk signature obtained in the step 90.

A deterministic-probabilistic evaluation step 94 of the applied reference risk signature and the associated feared threat scenario is implemented by nearest neighbor mathematical methods for example.

A step 96 (optional) of validation by interaction with an expert, belonging to a HILL (Human in the Loop Learning) process, is then implemented, and if the result of the validation (test 98) is negative, a modification of the reference risk signature in the database is applied, by reinforcement learning, and the steps 90, 92 and 94 are iterated.

The validation includes, in particular, the comparison between the reference risk signature and the risk signature obtained for the industrial system considered.

The expert then validates the reference data stored in the databases 22, 24.

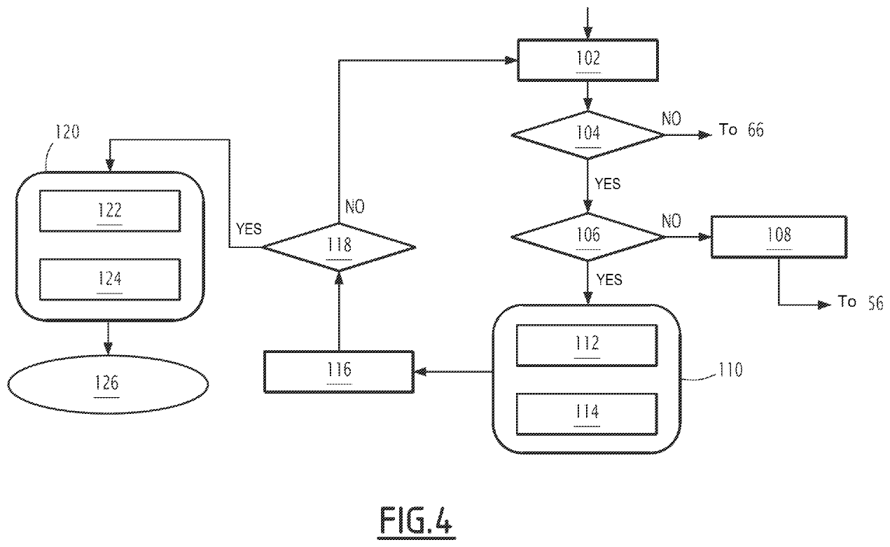

If the validation result is positive, the method continues toward a final phase 100 of detection and characterization within the method for detecting and characterizing of weak signals of risk exposure, the continuation being described below with reference to FIG. 4.

Such final detection and characterization phase comprises a step 102 of implementing a module for characterizing weak signals of risk exposure (or weak precursor signals), which makes a comparison of the computed risk predictive signature, or risk predictive signatures computed at a plurality of instants of time, with a predetermined reference risk signature.

In one embodiment, the reference risk signature is a threshold value, and a comparison to the threshold value is performed, and the detection of weak precursor signals is positive if the predetermined threshold value is exceeded by the predictive signature of the risk computed at least at one time t of the period considered. A plurality of threshold values defining a plurality of risk levels can be used, the threshold values being stored beforehand.

In another embodiment, the step 102 implements a comparison with one or a plurality of reference risk signatures computed and stored beforehand in the reference risk signature database 24, and the detection of weak precursor signals is positive if a distance between reference risk signatures and computed risk predictive signature is less than a predetermined distance threshold. Each of the risk signatures e.g. is characterized by a plurality of values at successive instants of time over a length of time for evaluating the risk signatures. In such case, the computation of a distance between risk signatures implements a distance between two curves, e.g. the weighted average of the point-to-point distances.

Moreover, a statistical uncertainty associated with the detection is systematically evaluated by one of the statistical methods of the prior art (normal law or Poisson's law).

In the event of detection of weak negative precursor signals (answer “no” to the test 104), the method returns to the step 66 of interactive validation by an expert.

In the event of detection of positive weak precursor signals (answer “yes” to the test 104), it is then verified (test 106) whether there is a reference risk signature close to the risk predictive signature among the reference risk signatures stored beforehand.

The proximity is evaluated based on a distance computation according to a predetermined distance measurement.

For example, as indicated above with reference to the step 102, a distance between two curves, a curve representative of a reference risk signature and a curve representative of the computed risk predictive signature, respectively, is computed, which can be used for finding the reference risk signature closest to the computed risk predictive signature. The distance between the reference risk signature closest to the computed risk predictive signature and the computed risk predictive signature is then compared to a distance threshold, and if it is less than the distance threshold, then the answer to the test 106 is positive.

In the event of a negative answer to the test 106, an interactive validation step 108 by an expert is used, followed by the step 56 of selecting learning models using artificial intelligence. In such a case, the learning process is restarted with a new learning model, e.g. the model parameters are changed, or another learning algorithm is chosen.

In the event of a positive answer to the test 106, in other words if a reference risk signature close to the risk predictive signature has been found, a display step 110 is implemented. The step comprises a display 112 of a predictive simulation of the risk of occurrence of the feared event and a step 114 of displaying the characteristics of the AI models used.

A new step 116 of interactive validation by an expert is optionally implemented.

In the event of negative validation (answer “no” to the test 118), the method returns to the step 102 of comparison with one or a plurality of reference risk signatures.

In the event of positive validation (answer “yes” to the test 118), a report generation step 120 is implemented, using (step 122) data from the databases stored beforehand, in particular using the associated threat scenarios and the associated risk map.

Thus, the operational experience (REX) database is enriched.

In particular, the threat scenario associated with the selected reference risk signature is displayed. Moreover, the parameters characterizing the applied risk model are displayed, along with the computed probabilistic uncertainties.

As an optional addition, a plan of proposals and recommendations is generated (step 124).

Recommendations for monitoring or shutting down certain equipment in the industrial system e.g., or for predictive maintenance applications, are implemented.

Thus, a report 126 is obtained, the report making possible, the informed decision-making of the risk detected, following the detection and the characterization of weak precursor signals.

An example of application in an industrial nuclear facility system will be described hereinafter with reference to FIG. 5.

A nuclear facility site 150 is schematically represented in FIG. 5.

The nuclear facility site 150 comprises two buildings 152, 154, the first building 152 housing a nuclear installation, the second building 154 comprising personnel offices. The facility 150 holds nuclear material under the nuclear material regulations.

In the present example application, the building 152 comprises zones with different levels of access, authorized access to all personnel having a first level of authorization, authorized regulated access to persons having a second level of authorization, and restricted access to persons having a third level of authorization, respectively.

The building 152 houses a restricted access zone 156 which in turn comprises a raw material storage cell 158 (restricted access zone), zones 160 for carrying out nuclear material conversion processes, aiming at obtaining a part or an object from raw material, such as casting, forging, press, machining, deep-drawing, welding, additive manufacturing or a combination of such processes, referenced as PROC_1 to PROC_n. The finished objects are stored in a separate restricted access cell 162.

Schematically, such industrial processes PROC_i, each housed in a separate cell 160 containing weighing devices and computers for entering data, follow one another in the industrial production chain, according to an industrial production chain, qualified and evaluated under quality assurance, authorizing, at the end of each validated step, the move from one process to the next PROC_i+1.

The arrows shown in FIG. 5 indicate the input, output and conversion flows.

The building 152 also houses zones 164, 166, 168, which are respectively a restricted access entrance zone 164, in wherein the arrival, unloading and transfer of raw materials take place, an exit area 166, wherein the exit transfer and the loading of finished objects take place, and a zone 168 of authorized access for personnel (changing rooms, offices, meeting rooms, etc.).

The building 154, separate from the building 152 housing the industrial installations, houses a cell 170 with restricted access, for the storage of sensitive data making possible a control of the operation of the industrial site, and offices 172 of authorized personnel with a regulated access level. The building 154 also includes a zone 174 of authorized access for personnel (offices, meeting rooms, etc.).

To ensure operational safety, operational responsibility is assigned to a facility manager (the term “manager” herein refers to all persons in charge, such as a person in charge and a substitute), who carries out checks throughout the entire facility 156. Moreover, each PROC_k industrial process is under the responsibility of a team leader.

The first level quality control is carried out by the persons in charge at the facility 156, as well as at the entrance 164 and exit 166 zones. Such control aims to ensure the quality of industrial production under quality assurance and the regulatory conformity of industrial processes in terms of the holding of nuclear materials (monitoring, accounting and physical protection of materials), the safety of the installation and of persons (physical protection of the installation, occupational risks, fire risk, risk of internal malice and of diversion, etc.), and environmental protection (control of wastes and prevention/management of risks and of internal and external threats).

Under the applicable regulations, a second-level control is carried out by a so-called second-level control cell, which is in charge with the control of all the installations of a site or of a plant. Such cell, which falls under the general direction of the site or of the plant, is usually located in an administrative building (building B), distinct from buildings housing industrial installations. The cell saves, controls and stores all sensitive data and numerical, quantitative and qualitative data relating to all installations and to each process.

Such second level control cell also has the mission of producing all regulatory documents for the authorities, of examining the requests from the authorities, in particular following inspections within the framework of inspection follow-up letters, of reporting events and incidents, of conducting investigation actions and of implementing corrective and preventive action plans.

The following risks are taken into account, denoted by R1 to R6, including 4 external threats and 2 internal threats.

The external threats taken into account are:
R1: risk of external aggressions;
R2: risk of physical intrusion into the facility;
R3: risk of theft and/or misappropriation of nuclear materials and/or sensitive objects;
R4: risk of cyber-attack and/or computer intrusion which can affect the integrity of sensitive data.

The internal threats considered are:
R5: risk of fraud and/or internal malice;
R6: risks of anomaly/critical malfunction.

Sources of internal threats are either internal malice, or negligence or incompetence.

Operating data of the nuclear facility are collected per campaign over a given time period. The time period e.g. is six months or one year.

In general, within the framework of the industrial operation routine, the facility manager collects and verifies the deviations and anomalies reported by the operational teams for each process, under the responsibility of the team leader concerned. Such deviations and anomalies are investigated to identify the causes thereof and to assess the consequences thereof.

The results of such investigations are subject to the assessment and to the independent validation of the second level control cell, which records the deviations and anomalies, either validates or fails to validate the “proven” nature thereof and classifies same, where appropriate, as events and individually assigns to same, a severity level G according to, e.g., the following rating:
G=1: minor event;
G=2: moderate event;
G=3: serious/significant event;
G=4: severe event.

The learning data provided at the input of the method are data collected during a campaign, or even during a predetermined number of previous campaigns.

The data collected are operational data of the nuclear facility.

The spatial perimeter considered is the perimeter of the industrial site, and it is preferentially modeled according to a multi-scale modeling as follows:
Scale 1: perimeter of the site 150 housing the nuclear facility 156;
Scale 2: perimeter of the facility;
Scale 3: perimeter of a cell housing a plurality of processes;
Scale 4: perimeter of a process.

In a more particular example, considering the perimeter of the process (scale 4), and a risk of theft and misappropriation of nuclear materials, the following identified initiating events are identified by the deployment of the process:
Event 1 (E₁) [symbol] intrusion of an uncertified/unauthorized operator into a restricted/regulated access cell, housing a sensitive process:

SIG_E₁(t)=f(G₁(x,t))ⁿw₁(x,t)σ₁(x,t)
Event 2 (E₂) [symbol] Modification of the process without prior authorization from the Facility Manager and not conforming with the regulatory framework:

SIG_E₂(t)=f(G₂(x,t))ⁿw₂(x,t)σ₂(x,t)
Event 3 (E₃) [symbol] Falsification of operating and control data:

SIG_E₃(t)=(G₃(x,t))ⁿw₃(x,t)σ₃(x,t)

In the present example, the parameters defining the elementary signatures of the initiating events are estimated by unsupervised machine learning algorithms or deep learning algorithms implementing neural networks on data coming from deviation and anomaly files available at the facility.

Concomitantly, a supervised machine learning estimation applied to data previously labeled by experts in the field, is applied.

By applying the incubation model to the three initiating events E₁, E₂, E₃, with f (Gᵢ(x, t))=2^{G}^{ᵢ} and <f (Gᵢ(x, t))∧f(Gⱼ(x,t))>=f(Gᵢ(x, t)×f (Gⱼ(s, t)) (n being equal to 1), we obtain the formula for the incubation of weak signals, precursor to the risk of theft and misappropriation of nuclear materials, at the scale of a process:

$$Γ ( x , t ) = {\sum }_{i \leq 3} {2}^{{G}_{i}} {w}_{i} ( x , t ) {σ}_{i} ( x , t ) + {\sum }_{j , k} {ξ}_{jk} {w}_{k} ( x , t ) {2}^{{G}_{j}} \times {2}^{{G}_{k}}$$

The severity is defined in the present example as follows:
G=0: non-event;
G=1: minor event;
G=2: moderate event;
G=3: serious/significant event;
G=4: severe event.

The severity G; hereinabove is equal to the value of G for the initiating event Eᵢ.

Moreover, the other functions are defined in the example by:
σ(x, t)=1 If the initiating event has a non-negligible probability of being realized, regardless of the severity of the impact thereof and of the consequences thereof, or if the initiating event has a near-zero probability of being realized, but a significant impact on the whole system.
σ(x, t)=0 if the initiating event has a near-zero probability of being realized with a near-zero impact.
ξ(x, t)={−1,0,1} depending on the effect (protective, neutral or negative) of the correlation of initiating events.

For the function w(x,t), the Vulnerability functions Vᵢₖ and Defense Barrier ωᵢₖ could be modeled as follows:

Vᵢₖ(x,t=−αᵢₖ(x)t+bᵢₖ(x)

ωᵢₖ(x,t)=cᵢₖ(t)

With for example aᵢₖ(x), bᵢₖ(x) and cᵢₖ(x) positive polynomial functions.

The parameters of such functions are computed by AI (“artificial intelligence”) learning as explained hereinabove.

Advantageously, the invention allows weak signals of exposure to a risk, in particular to a feared event, to be detected, which makes it possible to increase the security of the operation of industrial systems, and the upstream prevention of risks (overheating, breakdown, fire, etc.).

1. A method for detecting and characterizing weak signals of risk exposure in an industrial system, a weak signal being representative of an incubation of a feared event, from industrial system data collected by at least one sensor over a given time period, the method comprising the following steps, implemented by a processor:
from data relating to said industrial system, collected during said period, computation of a risk predictive signature defining an incubation function, the risk predictive signature comprising a first term obtained by summing elementary signatures associated with elementary initiating events, each elementary signature being dependent on parameters comprising a severity value of the elementary initiating event, a characteristic function of the elementary initiating event and a weighting function associated with the elementary initiating event, at least a part of said parameters being determined by implementing a neural network,
detection of the presence of at least one weak signal of risk exposure by comparing the computed risk predictive signature with predetermined reference risk signatures,
in the event of positive detection, determination of a reference predictive signature associated with the computed risk predictive signature and characterization of the risk associated with the reference risk signature, said characterization comprising a display of a threat scenario determined beforehand and recorded in association with said reference predictive signature.

2. The method according to claim 1, wherein the weighting function associated with the elementary initiating event is a deterministic-probabilistic function, dependent on a probability of said elementary initiating event related to said feared event.

3. The method according to claim 1, wherein the risk predictive signature includes a second term which is dependent on pairs of elementary initiating events and a characteristic inter-correlation function for each pair of elementary initiating events.

4. The method according to claim 1, wherein the computation of a risk predictive signature further takes into account, a probabilistic characteristic function of noise relative to the collected data.

5. The method according to claim 1, wherein the elementary signature of an elementary initiating event Eᵢ is provided by the following formula:
Sig_Eᵢ(t)=f(Gᵢ(x,t)ⁿwᵢ(x,t)σᵢ(x,t)
Where f(Gᵢ(x,t))ⁿ is a characteristic function of the severity of the elementary initiating event Eᵢ, defined over a spatial perimeter and over a time period, n being an integer parameter
σ(x,t) is the characteristic function of the elementary initiating event Eᵢ and
wᵢ(x,t) is the weighting function associated with the elementary initiating event Eᵢ.

6. The method according to claim 5, wherein the risk predictive signature is computed according to the formula:
$$Γ ( \text{} t ) = [ \text{} {\sum }_{i} S i {g}_{-} {E}_{i} ( t ) + {\sum }_{jk} {ξ}_{jk} {w}_{j} ( x , t ) {w}_{k} ( x , t ) < f ( {G}_{i} ( x , t ) ) ∧ f ( G , ( x , t ) ) > ] * B ( t ) ,$$
Where ξⱼₖ is a characteristic inter-correlation function between elementary initiating events Eⱼ and Eₖ, <f(Gᵢ(x, t))∧f(Gⱼ(x, t))> indicates a function linking the characteristic severity functions of the initiating events Eⱼ and Eₖ, and B(x,t) is a probabilistic function characterizing a noise.

7. The method according to claim 5, wherein the characteristic severity function of an elementary initiating event takes four different values representative of zero severity, minor severity, significant severity or severe severity, respectively.

8. The method according to claim 1, wherein the data relating to the industrial system are representative values of the equipment of the industrial system, and data are collected by one or a plurality of sensors.

9. The method according to claim 1, including, following the collection of data relating to the industrial system during said period, a preprocessing of said collected data so as to format said collected data into numerical data, and a classification by a classifier of said numerical data for obtaining parameter values associated with the elementary initiating events.

10. The method according to claim 1, including a phase of initializing a database of reference risk signatures, in relation to a set of feared events, depending on data collected for industrial systems and on expert validations, and a memorization of reference risk signatures, associated threat scenarios and an associated risk map.

11. A computer program including software instructions which, when executed by a programmable electronic device, use a method for detecting and characterizing weak signals of exposure to a risk according to claim 1.

12. A system for detecting and characterizing weak signals of risk exposure in an industrial system, a weak signal being representative of an incubation of a feared event, from industrial system data collected by at least one sensor over a given time period, the system comprising at least one computation system, including a processor configured for implementing:
a module for computing, on the basis of data relating to the industrial system collected during said period, a risk predictive signature, the risk predictive signature comprising a first term obtained by summing elementary signatures associated with elementary initiating events, each elementary signature being dependent on parameters comprising a severity value of the elementary initiating event, a characteristic function of the elementary initiating event and a weighting function associated with the elementary initiating event, at least a part of said parameters being determined by implementing a neural network,
a module for detecting the presence of at least one weak signal of risk exposure by comparing the computed risk predictive signature with predetermined reference risk signatures,
in the event of a positive detection, applying a module for determining a reference predictive signature associated with the predictive signature of the computed risk for characterizing the risk associated with said reference risk signature, including a module for displaying a threat scenario which was determined beforehand and recorded in association with said reference predictive signature.
